(19) United States
(12) Patent Application Publication
(10) Pub. No.: US 2009/0235898 A1
(43) Pub. Date: Sep. 24, 2009

(54) Fuel injector isolator

(76) Inventor: Jason C. Short, Henrietta, NY (US)

Correspondence Address: DELPHI TECHNOLOGIES, INC., M/C 480-410-202, PO BOX 5052, TROY, MI, 48007, US

(21) Appl. No.: 12/077,445

(22) Filed: Mar. 19, 2008

(51) Int. Cl. F02M 61/16

(52) U.S. Cl. 123/470

(57) ABSTRACT

A compression resistant isolator disposed between a direct fuel injector and a cylinder head of an internal combustion engine provides thermal, or thermal and vibrational isolation therebetween. A plurality of radially spaced rigid axial support members provide axial load support to maintain proper direct fuel injector positioning within the cylinder head bore. Spaces formed between the rigid axial support members may have isolation materials positioned therein. The implementation of the isolator may reduce the operating temperature of a fuel injector for direct injection, which is critical to avoid injector tip plugging.

### TECHNICAL FIELD

The present invention relates to fuel injection systems of internal combustion engines; more particularly, to fuel injectors for direct injection; and most particularly to a device and method for thermal and acoustic isolation of a fuel injector from a cylinder head.

### BACKGROUND OF THE INVENTION

Fuel injector systems that deliver fuel to the combustion chamber of an internal combustion engine have been known for many years. The typical fuel injection system draws fuel from a fuel tank to a fuel rail mounted adjacent to the cylinder bank of the engine. The fuel injectors are electromechanical devices that deliver fuel in precise amounts and times to the respective cylinder.

While the engine is running, the valve within each fuel injector is constantly being operationally cycled from an opened to a closed position. High frequency vibration is generated by the mechanical movement of the injector valves and low frequency pressure waves are generated by the movement of the fuel flowing through the injectors. Additionally, a substantial amount of heat generated in the combustion chambers of the cylinder heads may be transferred from the engine to the fuel injector.

In an engine having a Direct Fuel Injector (DFI) system, atomized fuel is sprayed by the injector directly into the combustion chamber of the cylinder head. The fuel injector tip portion of the DFI typically fits through a stepped bore defined in the cylinder head that has a peripheral bottom shoulder whose top surface provides a positive stop to the bottom surface of the body of the DFI. However, direct metal-to-metal contact between the bottom surface of the DFI body and the top surface of the shoulder allows for unmitigated transfer of the vibration from the DFI to the cylinder head and allows for the transfer of heat by thermal conduction from the cylinder head to the DFI. Allowing the vibration from the DFI to propagate into the combustion chamber can adversely effect the placement of the highly precise fuel spray pattern into the combustion chamber. Moreover, allowing thermal conduction of heat from the cylinder head to the DFI can lead to injector tip plugging thereby affecting fuel metering and injector spray pattern.

Prior attempts to isolate vibration and heat transfer between the DFI and the cylinder head have included, for example, the installation of a full-fitting isolation spacer between the bottom surface of the body of the DFI and the shoulder in the cylinder head bore such as a 360-degree plastic ring on top of a metal ring or a 360-degree rubber encapsulated metal ring. However, the high downward compressive pressure exerted on these existing rings and their plastic or rubber isolation materials during normal engine operation causes the materials to creep around the engaging surfaces, effectively reducing the isolation materials between the DFI and the cylinder head. Additionally, the large, cross-sectional area provided by the full-fitting isolation spacers increase the transfer of heat by conduction from the cylinder head to the DFI. The heat transferred by the spacer further promotes the creep of the existing plastic and rubber isolation materials.

What is needed in the art is a method for effectively thermally and acoustically isolating the fuel injector from the cylinder head of an internal combustion engine.

It is a principal object of the present invention to provide an isolator to be positioned between the fuel injector and the cylinder head that is thermally resistive and vibration absorbing and will not compress over time.

### SUMMARY OF THE INVENTION

Briefly described, a compression resistant isolator is positioned between a fuel injector and a cylinder head to minimize conductive heat transfer from the cylinder head to the fuel injector and to absorb vibration (noise) from the operating injector valve. The compression resistant isolator in accordance with the invention may be a spacer that holds the fuel injector and the cylinder head at a given axial distance from each other, thereby thermally and/or acoustically isolating the fuel injector from the cylinder head.

The spacer is designed to minimize the cross-sectional area for conductive heat transfer and to maintain the injector location relative to the cylinder head. The rigid parts of the spacer are preferably made of thermally resistive materials. The remaining volume of the spacer may be filled, for example, by injection molding, with vibration absorbing and thermally resistive materials, or may be filled with ambient air if thermal isolation is of primary importance. Furthermore, the spacer may be designed to inhibit or prevent the isolation material from creeping away from the engaging surfaces under the clamping load compressive pressure.

The implementation of the isolator in accordance with the invention may reduce the operating temperature of the fuel injector, especially of a direct fuel injector that is subjected to combustion chamber temperatures.

In one aspect of the invention, the spacer may be designed as a rigid ring including provisions for an o-ring and/or an inner overmold. The upper o-ring glands prevent compression of the ring, while the elastomeric parts absorb vibration.

In another aspect of the invention, the spacer may include two or more axial support members tied together by an annular collar to support the axial load of the injector. The surrounding volume and the radial space between the axial support members may be filled with a material that absorbs vibration and that is thermally non-conductive. In an alternative embodiment, the axial support members may be integral to the injector body eliminating the annular collar. The voids that exist between the axial support members may be filled with isolation material or ambient air.

In still another aspect of the invention, the spacer is designed as a ring including outwardly extending features that support the axial load of the injector. The spacer may be a deep drawn part that is preferably comprised of a metal. The spacer may be either overmolded for thermal isolation and/or vibration absorption or left as is to utilize ambient air as the thermal isolator.

In a further aspect of the invention, the spacer is formed of a powder metal. The voids in the powder metal provide a thermally non-conductive substrate. Notches formed on the interfacing surfaces of the spacer minimize thermal conduction between the injector and the cylinder head even further. The notches may also be filled with isolation material.

### BRIEF DESCRIPTION OF THE DRAWINGS

The present invention will now be described, by way of example, with reference to the accompanying drawings, in which:

FIG. 1 is a side elevational view of a fuel injector-cylinder head assembly of an internal combustion engine, in accordance with the invention;

FIG. 2 is a cross-sectional split view of an isolation spacer installed between the fuel injector and the cylinder head, in accordance with the invention;

FIG. 3 is a top plan view of a second isolation spacer, in accordance the invention;

FIG. 4 is an isometric view of the second isolation spacer integrated into the fuel injector; in accordance with the invention;

FIG. 5 is a top view of a third isolation spacer, in accordance with the invention;

FIG. 6 is a side elevational view of the third isolation spacer, in accordance with the invention;

FIG. 7 is a side elevational view of the third isolation spacer installed between the fuel injector and the cylinder head, in accordance with the invention;

FIG. 8 is a top plan view of a fourth isolation spacer, in accordance with the invention;

FIG. 9 is a side elevational view of the fourth isolation spacer, in accordance with the invention; and

FIG. 10 is a cross-sectional view of the fourth isolation spacer installed between the fuel injector and the cylinder head.

Corresponding reference characters indicate corresponding parts throughout the several views. The exemplification set out herein illustrates a preferred embodiment of the invention, in one form, and such exemplification is not to be construed as limiting the scope of the invention in any manner.

### DETAILED DESCRIPTION OF THE INVENTION

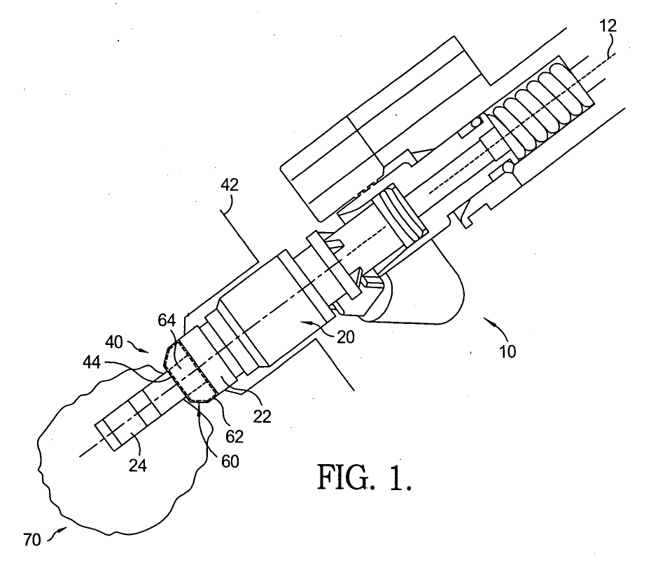

Referring to FIG. 1, a fuel injector-cylinder head assembly 10 of an internal combustion engine 70 includes a fuel injector 20, a cylinder head 40, and a compression resistant isolator 60 assembled there between. Fuel injector-cylinder head assembly 10 extends along an axis 12.

Fuel injector 20 includes a lower housing 22 and an injector tip 24 axially extending from lower housing 22. Cylinder head 40 includes a stepped housing 42 having a center opening 44. Fuel injector 20 is assembled in stepped housing 42 of cylinder head 40, such that stepped housing 42 of cylinder head 40 accommodates lower housing 22 of fuel injector 20 and such that injector tip 24 extends through center opening 44 of cylinder head 40. Fuel injector 20 may be, but is not limited to, a fuel injector for direct injection as shown in FIG. 1.

Isolator 60 is positioned within stepped bore 42 such that isolator 60 is positioned adjacent to lower housing 22 encircling injector tip 24. Accordingly, isolator 60 has an outer circumferential contour 62 that fits into stepped housing 42 and that is wider than center opening 44. Isolator 60 further includes a center aperture 64 adapted to receive injector tip 24. Isolator 60 is designed to withstand a compressive load from fuel injector 20. Isolator 60 is further designed with a reduced cross-sectional area to reduce conductive heat transfer from cylinder head 40 to fuel injector 20, and especially injector tip 24, while maintaining the location of fuel injector 20 relative to cylinder head 40. Isolator 60 is still further designed to absorb vibration (noise) from the injector's operating valve. Isolator 60 is formed of materials that will limit the isolator's compression and that provide thermal and/or acoustic isolation of fuel injector 20 from cylinder head 40. Isolator 60.may be formed from multiple materials. For example, the main body of isolator 60 may be formed of a compressively rigid and thermally resistive material and the remaining volume may be filled with a vibration absorbing and/or thermally resistive material, or may be left as is to use ambient air as a thermal isolator. Isolator 60 may be designed as an isolation spacer having a variety of configurations as shown in FIGS. 2-10.

Referring to FIG. 2, a first isolation spacer 100 is shown assembled within stepped housing 42 of cylinder head 40 and adjacent to lower housing 22 of fuel injector 20. As can be seen in the figure, isolation spacer 100 has an annular rigid body 110 that includes a radial flange 111 and a collar 113 forming recess 112 for radially receiving an o-ring 114. Radial flange 111 extends outwards from collar 113 and faces lower housing 22 of fuel injector 20. Collar 113 serves as a load bridge between the fuel injector and cylinder head thereby, while making minimal contact with the cylinder head, assisting in supporting an axial load of fuel injector 20, and preventing compression of o-ring 114. O-ring 114 disposed in recess 112 absorbs vibration from the cycling valve in fuel injector 20. O-ring 114 may be replaced with another elastomeric material, such as an inner elastomeric overmold.

To minimize conductive heat transfer from cylinder head 40 to fuel injector 20, body 110 may be formed of a thermally non-conductive or thermally resistive material. Furthermore, body 110 of spacer 100 includes a larger width section 115 and a reduced width section 116, that define a volume, such as chamber 45. As a result, contact areas 118 between spacer 100 and injector tip 24 of fuel injector 20 as well as between spacer 100 and stepped housing 42 of cylinder head 40 are minimized, thereby reducing the areas of the path available for heat transfer from the engine. Chamber 45 may be filled with an isolation material, such as a material that absorbs vibrations from the injector's operating valve and/or with a material that may also be thermally non-conductive or thermally resistive. For example, ambient air may be used as thermal isolation.

To further improve vibration-absorbing properties of spacer 100, recess 112 may be filled completely or partially with an isolation material that is thermally non-conductive and absorbs vibration. It may further be possible to form spacer 100 from a metal that is overmolded, for example, with a thermally non-conductive material or thermally resistive material.

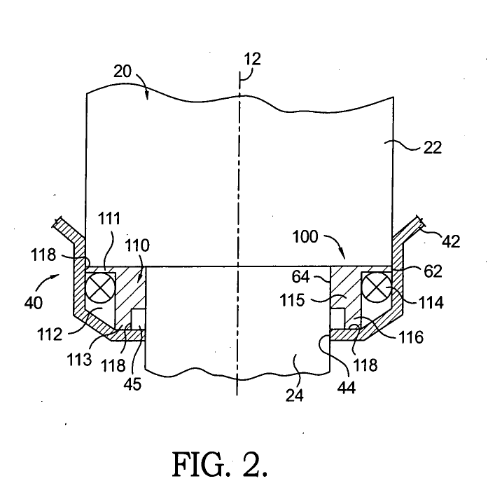

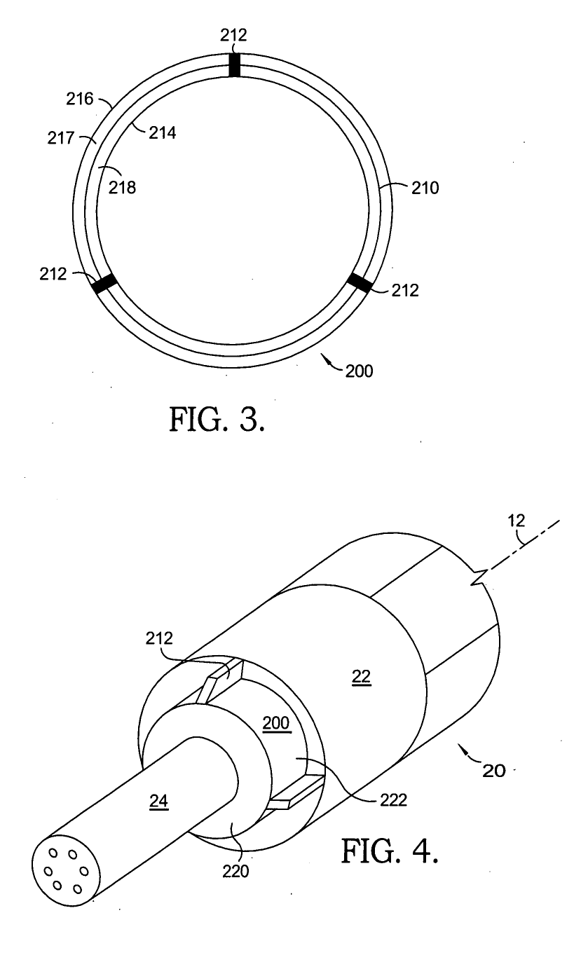

Referring to FIG. 3, a second isolation spacer 200 includes rigid axial support members 212 tied together by an annular rigid collar 210. Axial support members 212 support the axial load of fuel injector 20 When assembled, for example, in fuel injector-cylinder head assembly 10 shown in FIG. 1. Isolation spacer 200 including axial support members 212 may be a separate part as illustrated in FIG. 3 or may be integral with lower housing 22 of fuel injector 10 as illustrated in FIG. 4.

Axial support members 212 extend from an inner diameter 214 to an outer diameter 216 of spacer 200. In the example shown, axial support members 212 do not extend radially beyond an outer circumferential contour of lower housing 22 of fuel injector 20. Collar 210 may be positioned between inner diameter 214 and outer diameter 216, for example, in the center of axial support members 212. In the example shown having three support members, support members 212 may be preferably spaced apart from each other at 120 degrees. Arrangements of axial support members 212 at other angles may be possible. While three axial support members 212 are shown in FIGS. 3 and 4, it may be possible to design spacer 200 with two or more axial support members 212.

A radial space 217 formed between axial support members 212, collar 210, and an outer diameter 216 and a radial space 218 formed between axial support members 212, collar 210, and an inner diameter 214 may be filled with a material that absorbs vibrations form the oscillating fuel injector 20 and that may also be thermally non-conductive or thermally resistive. If not filled with a vibration absorbing material, ambient air is used as thermal isolation in spaces 217 and/or 218. Collar 210 may be formed from a thermally resistive material.

When integrated into lower housing 22 of fuel injector as shown in FIG. 4, collar 210 may be eliminated by extending axial support members 212 radially from a reduced diameter section 220 of lower housing 22. The radial space 222 between axial support members 212 and between reduced diameter section 220 may be filled with a material that absorbs vibrations from the oscillating fuel injector 20 and that may also be thermally non-conductive or thermally resistive. If not filled with a vibration absorbing material, ambient air is used as thermal isolation in space 222.

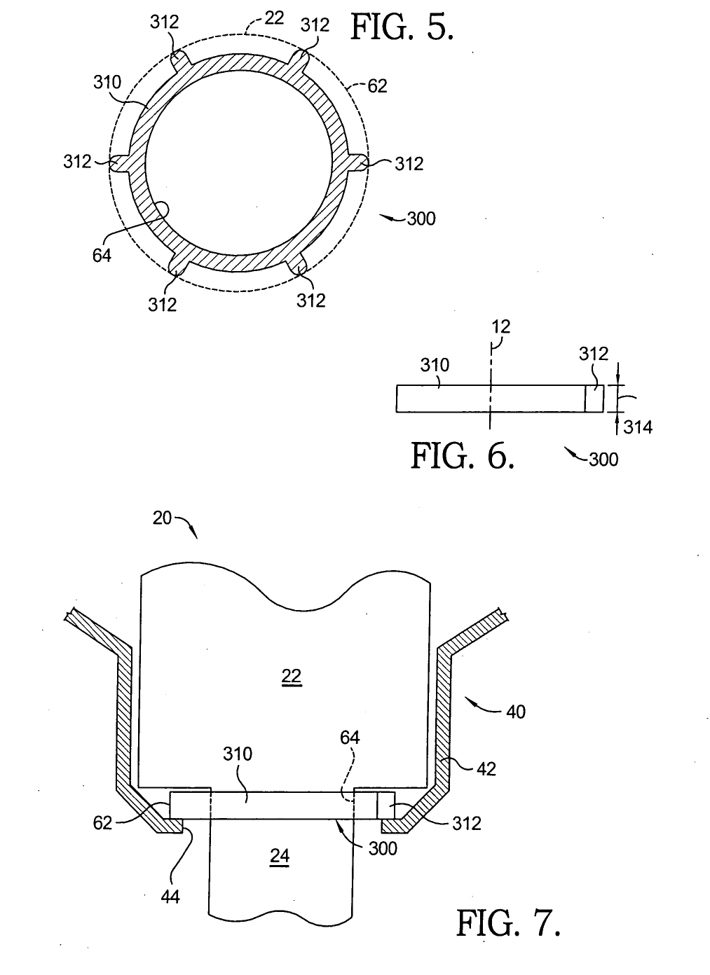

Referring to FIGS. 5 through 7, a third isolation spacer 300 includes an annular body 310 and a plurality of rigid tabs 312 radially spaced along and outwardly protruding from an outer circumferential contour of body 310. Body 310 and tabs 312 have preferably the same height 314 as shown in FIG. 6. Tabs 312 help support the axial load of fuel injector 20 when assembled between fuel injector 20 and cylinder head 40 as shown in FIG. 7.

Body 310 and tabs 312 may be formed from a rigid thermally resistive material or may be, for example, a stamped or deep drawn part comprised, for example, of a metal. The deep drawn part may be overmolded with an elastomeric material for vibration absorption or may be left as is to utilize ambient air as the thermal isolator. It may further be possible to fill the radial space between tabs 320 with a material that is vibration-absorbent and that may also be thermally non-conductive.

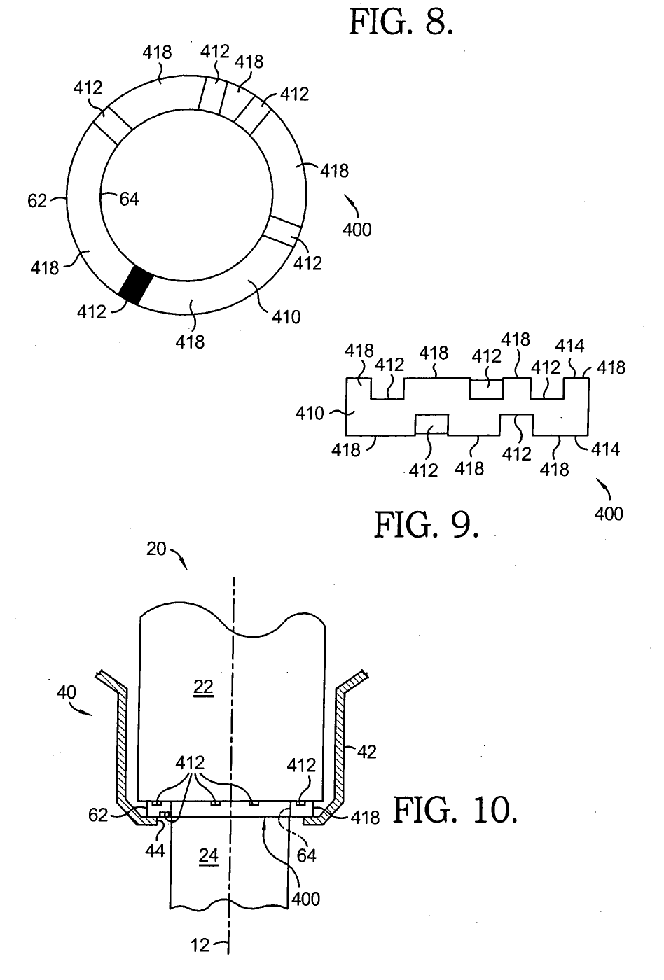

Referring to FIGS. 8 through 10, a fourth isolation spacer 400 includes an annular body 410 having a plurality of notches 412 integrated in the interfacing surfaces 414. Spacer 400 may be formed from a powder metal. The voids in the powder metal provide a thermally non-conductive substrate for body 410.

Notches 412 minimize contact areas 418 between spacer 400 and lower housing 22 of fuel injector 20 as well as between spacer 400 and stepped housing 42 of cylinder head 40, thereby minimizing thermal conduction between fuel injector 20 and cylinder head 40 when spacer 400 is installed between fuel injector 20 and cylinder head 40. The size and number of notches 412 is chosen such that a desired support of the axial load of fuel injector 20 by spacer 400 is achieved. While notches are shown in FIG. 9 as having a rectangular cross-section, other cross-sections may be used. It may be possible to fill notches with an acoustical and/or thermal isolation material.

The implementation of a compression resistant isolator 60 (as shown in FIG. 1), such as isolation spacers 100, 200, 300, and 400 (as shown in FIGS. 2-10) thermally isolates fuel injector 20 from cylinder head 40 reducing the operating temperature of the tip of the fuel injector. By keeping the temperature of injector tip 24 relatively low, plugging of the injector tip 24 is reduced.

Furthermore, implementation of a compression resistant isolator 60 (as shown in FIG. 1), such as isolation spacers 100, 200, 300, and 400 (as shown in FIGS. 2-10) acoustically isolates fuel injector 20 from cylinder head 40 by absorbing vibration (noise) from the oscillating fuel injector 20.

While the invention has been described by reference to various specific embodiments, it should be understood that numerous changes may be made within the spirit and scope of the inventive concepts described. Accordingly, it is intended that the invention not be limited to the described aspects, but will have full scope defined by the language of the following claims.

What is claimed is:

1. A fuel injector-cylinder head assembly of an internal combustion engine, comprising:
a compression resistant isolator assembled between a fuel injector and a cylinder head;
wherein said isolator includes reduced cross-section areas that minimize contact areas between said cylinder head and said isolator and between said isolator and said fuel injector; and
wherein said isolator includes a volume formed by said reduced cross-section areas that is filled with an isolation material that is at least thermally resistive.

2. The fuel injector-cylinder head assembly of claim 1, wherein said volume is at least partially filled with a vibration absorbing material, and wherein said isolator acoustically isolates said cylinder head from said fuel injector.

3. The fuel injector-cylinder head assembly of claim 1, wherein said isolator includes an outer circumferential contour adapted to fit into a stepped housing of said cylinder head, and wherein said isolator includes a center aperture adapted to receive an injector tip of said fuel injector.

4. The fuel injector-cylinder head assembly of claim 1, wherein said isolator includes a main body formed of a rigid and thermally resistive material.

5. The fuel injector-cylinder head assembly of claim 1, wherein said isolator includes an annular body that withstands a compressive load of said fuel injector.

6. The fuel injector-cylinder head assembly of claim 1, wherein said isolator utilizes ambient air as said isolation material.

7. The fuel injector-cylinder head assembly of claim 1, wherein said isolator maintains location of said fuel injector relative to said cylinder head.

8. An isolation spacer for a fuel injector-cylinder head assembly of an internal combustion engine, comprising:
an annular rigid body;
features integral with said body, wherein said features support an axial load of said fuel injector contacting said body and extending through said body; and wherein said features minimize the cross-sectional area for conductive heat transfer from said cylinder head to said fuel injector; and
spaces formed between said features, wherein said spaces thermally and acoustically isolate said fuel injector from said cylinder head.

9. The isolation spacer of claim 8, wherein said features include provisions for radially receiving an elastomeric material.

10. The isolation spacer of claim 9, wherein said elastomeric material is an o-ring.

11. The isolation spacer of claim 8, wherein said spaces are formed between larger width sections and reduced width sections of said body.

12. The isolation spacer of claim 8, wherein said spaces are filled with an isolation material.

13. The isolation spacer of claim 8, wherein said spaces are filled with a material that is vibration absorbent and thermally non-conductive or thermally resistive.

14. The isolation spacer of claim 8, wherein said spaces are filled with ambient air.

15. The isolation spacer of claim 8, wherein said features include at least three rigid axial support members, wherein said body is an annular rigid collar that ties said axial support members together.

16. The isolation spacer of claim 15, wherein said space includes a first radial space formed between said axial support members, said collar, and an outer diameter and a second radial space formed between said axial support members, said collar, and an inner diameter.

17. The isolation spacer of claim 8, wherein said features include a plurality of rigid tabs radially spaced along and outwardly protruding from an outer circumferential contour of said body.

18. The isolation spacer of claim 8, wherein said body is selected from a group consisting of a stamped part and a deep drawn part.

19. The isolation spacer of claim 8, wherein said body is overmolded with an elastomeric material.

20. The isolation spacer of claim 8, wherein said features are integral with a lower housing of said fuel injector.

21. The isolation spacer of claim 8, wherein said spaces include a plurality of notches integrated in interfacing surfaces of said body forming said features.

22. The isolation spacer of claim 8, wherein said body is formed from a powder metal.

23. A method for thermal and acoustic isolation of a fuel injector from a cylinder head of an internal combustion engine, comprising the steps of:
assembling a compression resistant isolator into said cylinder head; and
assembling said fuel injector in said cylinder head such that an injector tip of said fuel injector extends through said isolator and said stepped housing, and such that said isolator is positioned between said cylinder head and said fuel injector.

24. The method of claim 23, further comprising the steps of:
integrating features into said isolator to minimize a contact area between said isolator and said cylinder head and a contact area between said isolator and said fuel injector and to support an axial load of said fuel injector;
integrating spaces into said isolator; and
using said spaces for thermal isolation of said fuel injector from said cylinder head.

25. The method of claim 24, further comprising the steps of:
filling said spaces with a vibration-absorbing material; and
using said spaces for acoustical isolation of said fuel injector from said cylinder head.
